(19) United States
(12) Patent Application Publication
(10) Pub. No.: US 2007/0183109 A1
(43) Pub. Date: Aug. 9, 2007

(54) Safety circuit technique for high current shut-down

(75) Inventors: Lance Chandler, Gig Harbor, WA (US); David Sorlien, Escondido, CA (US); Don Buckingham, Greenville, OH (US)

Correspondence Address: WALLACE G. WALTER, 5726 CLARENCE AVE, ALEXANDRIA, VA, 22311-1008, US

(73) Assignee: Poweready, Inc., Milpitas, CA (US)

(21) Appl. No.: 10/778,894

(22) Filed: Feb. 13, 2004

Related U.S. Application Data
(60) Provisional application No. 60/447,478, filed on Feb. 13, 2003.

(51) Int. Cl. H02H 3/08

(52) U.S. Cl. 361/93.1

(57) ABSTRACT

A safety circuit technique for high current shut-down monitors a battery pack and, when certain conditions exist, performs a series of safety measures, or a safety checklist and actions, to safely and quickly turn the battery cell off. In a preferred embodiment, diodes are used to prevent the IC drive current from being exceeded.

### RELATED APPLICATION

This application claims the benefit of priority to U.S. Provisional Patent Application No. 60/447,478 filed Feb. 13, 2003, and currently co-pending.

### FIELD OF THE INVENTION

The present invention relates generally to a safety system used in computer shutdown system. More specifically to the method used in circuits for the safety of computer shut down systems.

### BACKGROUND OF THE INVENTION

In a device containing a battery system where an error occurs, such as an over-current being supplied from the battery pack, it is imperative to remove the cell from the circuit as quickly as possible. Despite the existence of fast switching transistors, current safety circuits inherently contain a delay in the disconnect of the affected cell. Unfortunately, any delay, even a very brief delay, can damage or destroy the battery cell.

### DESCRIPTION OF THE PREFERRED EMBODIMENT

The Safety Circuit Technique for High Current Shut-Down of the present invention monitors a battery pack and, when certain conditions exist, performs a series of safety measures, or a safety checklist and actions, to safely and quickly turn the battery cell off. In a preferred embodiment, diodes are used to prevent the IC drive current from being exceeded.

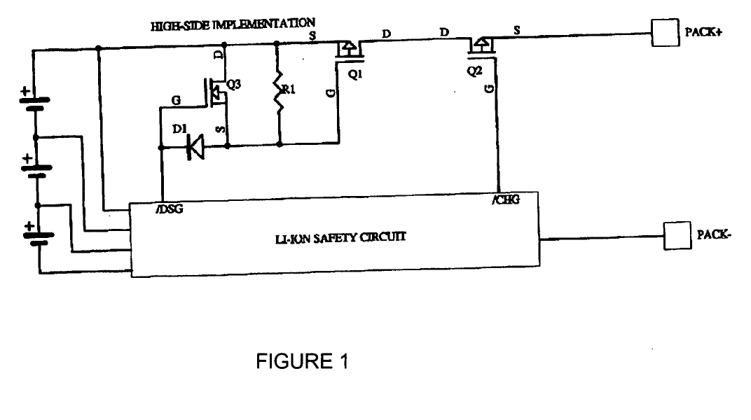

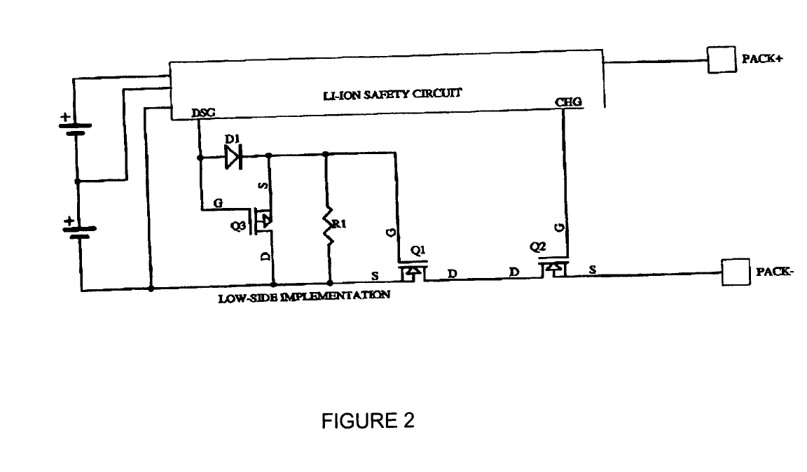

Referring to FIG. 1, a preferred embodiment of the safety circuit of the present invention is shown. This circuit is for a high-side implementation of the safety circuit. FIG. 2 depicts a preferred embodiment of the safety circuit of the present invention is shown. This circuit is for a low-side implementation of the safety circuit.

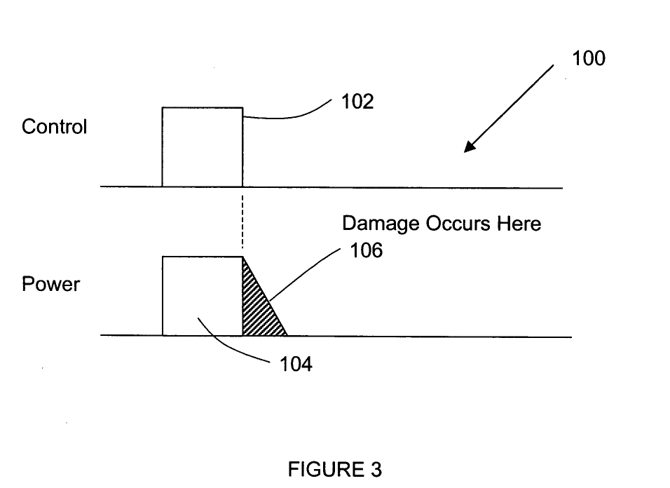

Referring to FIG. 3, a diagram showing the discharge signal on the safety circuits of FIGS. 1 and 2, and the resulting output current (power) is generally designated 100. Control signal 102 is in the “on” state, and at results in a corresponding non-zero power output 104. However, when an error occurs, the control signal 102 goes to the “off” state. This “off” state turns the switching transistors within the safety circuit to a non-conductive state, whereby the output power goes to zero. However, since there is an inherent level of capacitance within the switching transistors (preferably Field Effect Transistors (“FET”)), at the trailing edge of the power output exists a short-circuit current area 106. The short-circuit current area 106 is where the damage occurs to the safety circuit by, among other items, exceeds the power rating of the FET. To eliminate the formation of the short circuit current 106, a diode Dl is inserted into the circuit to prevent the IC drive current from being exceeded, as shown in FIGS. 1 and 2.

1. A safety circuit technique for high current shut-down, includes the steps of:
monitoring a battery pack;
performing a series of safety measures; and
turning off said battery cell.
